(19) United States
(12) Patent Application Publication
(10) Pub. No.: US 2023/0102866 A1
(43) Pub. Date: Mar. 30, 2023

(54) NEURAL DEEP EQUILIBRIUM SOLVER

(71) Applicant: Robert Bosch GmbH, Stuttgart (DE)

(72) Inventors: Shaojie BAI, Pittsburgh, PA (US); Vladlen KOLTUN, Jackson, WY (US); Jeremy KOLTER, Pittsburgh, PA (US); Devin T. WILLMOTT, Pittsburgh, PA (US); João D. SEMEDO, Pittsburgh, PA (US)

(21) Appl. No.: 17/954,011

(22) Filed: Sep. 27, 2022

Related U.S. Application Data
(60) Provisional application No. 63/249,169, filed on Sep. 28, 2021.

(51) Int. Cl. G06N 3/08; G06N 5/04

(52) U.S. Cl. CPC G06N 3/08; G06N 5/04

(57) ABSTRACT

Systems and methods for operating a deep equilibrium (DEQ) model in a neural network are disclosed. DEQs solve for a fixed point of a single nonlinear layer, which enables decoupling the internal structure of the layer from how the fixed point is actually computed. This disclosure discloses that such decoupling can be exploited while substantially enhancing this fixed point computation using a custom neural solver. The solver disclosed herein uses a parameterized network to both guess an initial value of the optimization and perform iterative updates in a method that can be trained end-to-end

### CROSS-REFERENCE TO RELATED APPLICATIONS

This application claims priority to and the benefit of U.S. Provisional Application No. 63/249,169, filed Sep. 28, 2021, the entire disclosure of which is hereby incorporated by reference herein.

### TECHNICAL FIELD

The present disclosure relates to computer systems that have capability for artificial intelligence, including neural networks. In embodiments, this disclosure relates to a solver for inference in a deep equilibrium (DEQ) neural network model.

### BACKGROUND

Neural networks are a subset of machine learning and are at the crux of deep learning algorithms. Neural networks include node layers containing an input layer, one or more hidden layers, and an output layer. Each node connects to another and has an associated weight and threshold. If the output of any individual node is above a threshold, that node is activated, sending data to the next layer of the network.

Recent developments have been made in implicit layers of neural networks. The basics of an implicit layer is that instead of specifying how to compute the layer's output from the input, one specifies the conditions that one wants the layer's output to satisfy.

One class of implicit layer models is a deep equilibrium (DEQ) model. DEQ modeling includes specifying a layer that finds the fixed point of some iterative procedure. A multiscale deep equilibrium model (MDEQ) directly solves for and backpropagates through the equilibrium points of multiple feature resolutions simultaneously, using implicit differentiation to avoid storing intermediate states.

### SUMMARY

According to one embodiment, a computer-implemented method of inferring data in a deep equilibrium (DEQ) neural network is provided. The computer-implemented method includes: receiving an input from a sensor at the DEQ neural network that is operated by a trained hypersolver stored in memory; providing a first output of the hypersolver after a first iteration of the hypersolver; based on the first output, begin performing a number of additional iterations of the hypersolver, wherein each additional iteration of the hypersolver is based on an output of a previous iteration of the hypersolver, wherein for each additional iteration: (i) a weight parameter and an additional parameter are determined based on the hypersolver, and past residuals from previous iterations of the hypersolver, and one of the past residuals from the previous iterations is updated based on the weight parameter and the additional parameter; and after the number of additional iterations of the hypersolver are complete, providing an output of the DEQ neural network based on the weight parameter, the additional parameter, and the updated past residuals.

According to another embodiment, a computer-implemented method for training a hypersolver for inference in a deep equilibrium (DEQ) neural network. The method includes (i) receiving an input from a sensor at the DEQ; (ii) determining a first fixed point of the DEQ based on the input and a solver; (iii) determining a second fixed point of the DEQ based on the input and a hypersolver; (iv) deriving a loss for the hypersolver, wherein the loss for the hypersolver includes a fixed-point convergence loss representing a difference between an output of the solver and an output of the hypersolver; (v) updating parameters of the hypersolver using loss gradients of the loss for the hypersolver; (vi) repeating steps (ii)-(v) until convergence of training of the hypersolver; and (vi) outputting a trained hypersolver for use in inference in the DEQ.

According to another embodiment, a system including a machine-learning network. The system includes an input interface configured to receive, at a deep equilibrium (DEQ) neural network operated by a trained hypersolver stored in memory, input data from a sensor. The system also includes a processor in communication with the input interface and programmed to: receive the input data from the sensor; provide a first output of the hypersolver after a first iteration of the hypersolver; based on the first output, begin performing a number of additional iterations of the hypersolver, wherein each additional iteration of the hypersolver is based on an output of a previous iteration of the hypersolver, wherein for each additional iteration: (i) a weight parameter and an additional parameter are determined based on the hypersolver, and past residuals from previous iterations of the hypersolver, and one of the past residuals from the iterations is updated based on the weight parameter and the additional parameter; and after the number of additional iterations of the hypersolver are complete, provide an output of the DEQ neural network based on the weight parameter, the additional parameter, and the updated past residuals.

### BRIEF DESCRIPTION OF THE DRAWINGS

FIG. 1 shows a system for training a neural network, according to an embodiment.

FIG. 2 shows a computer-implemented method for training and utilizing a neural network, according to an embodiment.

FIG. 3A is a flow chart for an algorithm that utilizes a hypersolver for inference in a machine learning model such as a Deep Equilibrium Model (DEQ), according to an embodiment.

FIG. 3B is an algorithm corresponding to the flow chart of FIG. 3A

FIG. 3C is a flow chart for a training algorithm for training the hypersolver for inference in a machine learning model, according to an embodiment.

FIGS. 4A-4C show comparisons of classic and neural fixed-point solvers on DEQ models, wherein FIG. 4A shows the comparison on Wikitext-103 language modeling, FIG. 4B shows the comparison on ImageNet classification, and FIG. 4C shows the comparison on Cityscapes semantic segmentation.

FIG. 4D shows graph comparisons of the small training overhead of the disclosed hypersolver.

FIG. 5 depicts a schematic diagram of an interaction between a computer-controlled machine and a control system, according to an embodiment.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to an embodiment.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver, that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The methods and systems described herein introduce a new solver for inference in deep equilibrium (DEQ) machine learning models, also referred to as DEQs. DEQs are a recent and very active area of research. This disclosure is an example of an implicit deep learning layer; instead of a layer as a simple function with an explicit expression that can be evaluated to receive the output, an implicit layer provides some analytical condition that the output of the layer must satisfy. DEQs have been shown to offer comparable performance to traditional network architectures while being significantly more memory-efficient. Unfortunately, this often comes at the cost of slower inference times, and past attempts to speed up inference in DEQs have done so at the cost of model accuracy (e.g., solver stopping early). Using the neural solver introduced in this disclosure, the inference speed can substantially increase with no real impact on the model's performance. Specifically, the solver disclosed herein uses a parameterized network to both guess an initial value of the optimization and perform iterative updates, in a method that generalizes a learnable form of Anderson acceleration and can be trained end-to-end. Such a solution is particularly well suited to the implicit model setting because inference in these models requires repeatedly solving for a fixed point of the same nonlinear layer for different inputs, which is performed well with the network described herein using the solver described herein.

Recent progress on implicit networks, such as Neural ODEs (NODEs) and DEQs, has motivated this novel class of networks to the forefront of deep learning research. Instead of stacking a series of operators hierarchically, implicit models define their outputs as solutions to nonlinear dynamical systems. For example, DEQ models define their outputs as fixed points (a.k.a. equilibria) of a layer f_{θ} and input x; i.e., output z*=f_{θ}(z*, x). Then, in the backward pass, a DEQ implicitly differentiates through the final fixed point z*, regardless of how forward pass is computed in the first place. Such insulated forward and backward passes enable an equilibrium model to leverage arbitrary black-box solvers to reach the fixed point without storing intermediate activations at training time, thus consuming constant training memory.

However, it is also well-known that these implicit models are slow. For example, Neural ODEs can take well over 100 forward solver iterations (i.e., evaluations of f_{θ}) even on MNIST classification, and have been found challenging to scale to high-dimensional settings. Past DEQs have been scaled to realistic tasks, but the computational overhead of iterative fixed-point solvers (e.g., 30 forward iterations in a DEQ-Transformer) is magnified by the scale of these tasks and can render the model 4-6 times slower than state-of-the-art explicit networks at inference time.

One benefit of DEQ's formulation is the fact that they decouple the representational capacity (determined by f_{θ}) and forward computation (controlled by the solver). Therefore, given a trained DEQ, one can trade off inference time and the accuracy of the estimated fixed point by simply reducing the number of solver iterations. However, this trade-off can be highly risky: as the inference speed is increased by reducing the number of solver iterations and thus the quality of fixed point estimates, model accuracy also degrades drastically.

This disclosure shows that it is possible to shift the DEQ speed/accuracy trade-offs by customizing the solver. Prior work on equilibrium models relies on classic solvers, which are manually designed and generic (e.g., Broyden's Method). This disclosure proposes a tiny, learnable, and content-aware solver module that is automatically customized to a specific DEQ. This new solver—also referred to as a hypersolver herein—comprises at least two parts. First, a learned initializer is introduced that estimates a good starting point for the optimization. Second, a generalized parameterized version of Anderson mixing is introduced that learns the iterative updates as an input-dependent temporal process. Overall, the hypersolver consumes a very small number of parameters. Since f_{θ} is frozen when the hypersolver is trained, the training is very fast and does not compromise generalization. Experiments show that these neural equilibrium solvers are fast to train (only taking an extra 0.9-1.1% over the original DEQ's training time), require few additional parameters (1-3% of the original model size), yet lead to a 1.6-2× speedup in DEQ network inference without any degradation in accuracy across numerous domains and tasks.

First, an explanation of equilibrium models and fixed point solvers may provide some context. Consider a deep neural network with hidden layers z and activations f such that z^{[i+1]}=f(z^{[i]}, θᵢ, c(x)) for i=0, 1, 2, . . . , L with weights θᵢ and previous layer inputs c(x) are both tied across layers, i.e., θᵢ=θ∀i. Some of these activations f may exhibit an attractor property, i.e., there exists a fixed point z* such that z*=f(z*, θ, c(x)) and

$${lim}_{L \to ∞} {\underbrace{( f ∘ … ∘ )}}_{L - times} ( {z}^{[ 0 ]} , θ , c ( x ) ) = {z}^{*} ,$$

i.e., the repeated application of f for an initial activation z^{[0]} converges to a fixed point z*. If this is the case, the iterated function application may be equivalently replaced by a numerical method to find the fixed-point directly (which is referred to as the “solver” in this disclosure). This shifts the problem from computing the forward and backward passes for multiple layers to computing and optimizing the fixed point directly via numerical methods. This approach is termed a Deep Equilibrium Model (DEQ).

While DEQs have been shown to perform comparably to traditional network architectures (i.e., explicit networks) on a variety of domains, they suffer from multiple downsides, such as: (1) growing instability during training; (2) inefficiency compared to explicit networks; (3) brittleness to architectural choices; and (4) dependency on the choice of solver. In particular, the choice of solver significantly impacts the inference speed for DEQs, which is an issue this disclosure focuses on.

With more specifics regarding DEQs, given a layer (usually a shallow block; e.g., self-attention) f_{θ} and an input x, a DEQ model aims to solve for an “infinite-level” feature representation without actually stacking the f_{θ} layer infinite times. Instead, one can solve directly for the fixed point z* of the system:

g_{θ}(z*, x):=f_{θ}(z*, x)−z*=0.

The fixed point can be estimated by quasi-Newton (or Newton's) methods, which provide superlinear (or even quadratic) convergence. Subsequently, in the backward pass, one can implicitly differentiate through the equilibrium point, even without knowledge of how it is estimated, and produce gradients with respect to the model parameters θ by solving a Jacobian-based linear equation:

$$\frac{\partial ℓ}{\partial θ} = \frac{\partial ℓ}{\partial {z}^{*}} {( I - {\underbrace{\frac{\partial {f}_{θ} ( {z}^{*} , x )}{\partial {z}^{*}}}}_{Jacobian of {f}_{θ}} )}^{- 1} \frac{\partial {f}_{θ} ( {z}^{*} , x )}{\partial θ} = - \frac{\partial ℓ}{\partial {z}^{*}} {{J}_{g} ( {z}^{*} )}^{- 1} \frac{\partial {f}_{θ} ( {z}^{*} , x )}{\partial θ} .$$

An important message from the Jacobian-based linear equation above is that the backward pass can be computed with merely the knowledge of z*, irrespective of how it is found. And, in fact, J_{g}(z*) can be directly replaced with with −I (i.e., Jacobian-free backward pass), which significantly accelerates training.

Regarding fixed-point solvers for DEQs, there are a number of techniques for finding the fixed points of DEQs. One technique is to use Broyden's method, the memory consumption of which grows linearly with the number of iterations since all low-rank updates are stored. Another technique is Anderson acceleration (AA), a lightweight solver that is provably equivalent to a multi-secant quasi-Newton method. A main idea of AA is to maintain a size-m storage of the most recent steps, and update the iteration as a normalized linear combination of these steps with weights α₁ (step 3). In the canonical AA algorithm, the weights are computed in a greedy manner at each step to minimize the linear combination:

$${α}^{k} = arg {min}_{α ∈ {ℝ}^{{m}_{k} + 1}} {‖ {G}^{[ k ]} α ‖}_{2} , s . t . {1}^{⊤} α = 1 ,$$

where G^{[k]=[g}_{θ}(z^{[k-m}^{_{k]}}) . . . g_{θ}(z^{k})] are the past (up to m+1) residuals; typically, β=1 and m≤5. The above equation can be solved by a least-squares method. The fixed point iteration can start with an initial estimate z^{[0]} that is either 0 or a random sample from [symbol] (0, I).

While classic fixed-point estimation algorithms are already known, they are generic and make minimal assumptions about the specific problem being solved. For example, while prior work has acknowledged that tuning m (and mₖ) as well as varying β=(βₖ)_{k=0, . . . , K} for each Anderson iteration k could accelerate AA's convergence to the fixed point, this is rarely considered in practice because it's unclear what schedule should be applied to these parameters.

This disclosure proposes to make fixed-point solvers for DEQ models learnable and content-based, which is made possible by the properties of implicit models. First, unlike generic fixed-point problems, the nonlinear system for each DEQ is uniquely defined by the input x (e.g., an image, etc.): z*(x)=z*=f_{θ}(z*, x). This opens the door to learning to make an informed initial guess, followed by content-based iterative updates in the solver. Second, due to implicit models' disentanglement of representation capacity with forward computation, a goal of improving solvers is decoupled from the original learning goal of the DEQ model itself (e.g., to better predict the classes). Hence, this neural solver can be trained in a lightweight manner and with direct supervision by the “groundtruth” fixed-point solutions.

For a given frozen DEQ layer f_{θ} and input x, access to its exact fixed point can be assumed as z*=z*(x)=f_{θ}(z*, x), which can be obtained by taking a classic solver (e.g., Broyden's method) and running it for as many iterations as needed (e.g., 100 steps) to a high level of precision.

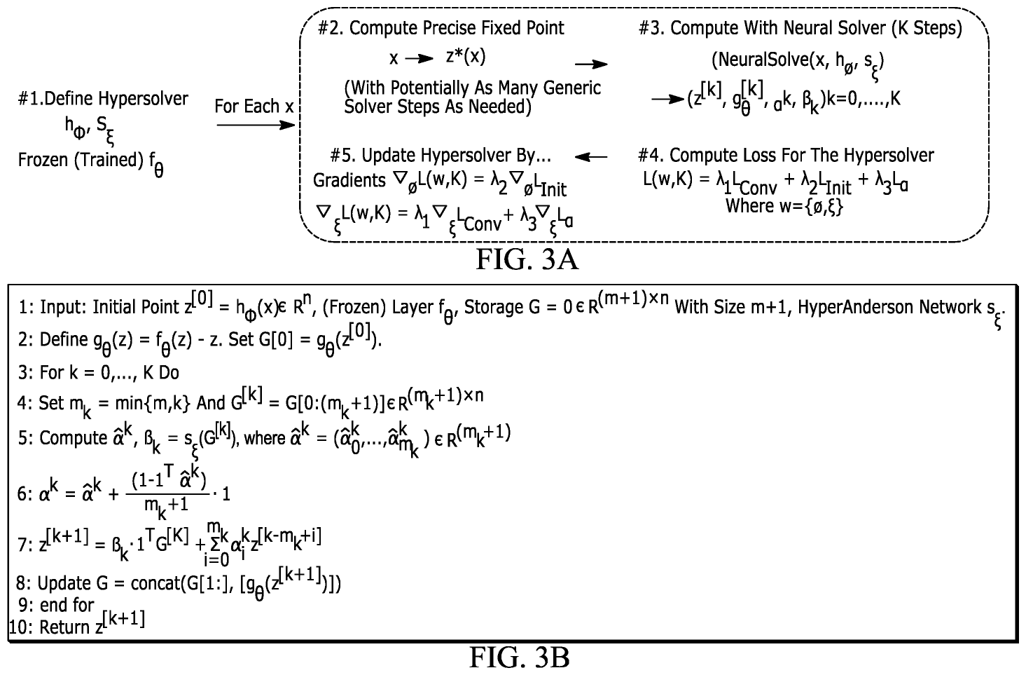

The overall structure of the hypersolver of this disclosure is shown in FIG. 3A. A tiny neural network is used, parameterized by ω={Ø, ξ} (explained below) to learn the initialization and iterative solving process, and the learnable solver for some K steps is unrolled to yield a prediction z^{[K]}(x). To train this neural solver, an objective [symbol] (ω, K) (discussed below) is minimized by backpropagating through this K-step temporal process. The original DEQ parameters θ are frozen, and only the hypersolver parameters ω are trained here. The ground-truth label y (e.g., the class of an image) of input x is not needed for this process, which means these neural equilibrium solvers can also be fine-tuned after deployment, at inference time.

Regarding an initializer, the setting of initial values can have a significant impact on the optimization process and its convergence speed. An input-dependent guess with a tiny neural network h_{Ø}: z^{[0]=h}_{Ø}(x) is therefore provided, where Ø are the parameters. Note that the goal of the initializer is not to solve the underlying problem (e.g., classify an image), but only to yield a quick initial estimate of the fixed point. For example, in language modeling, where x∈ [symbol] ^{T×d} is a length-T sequence, the following can be set

h_{ϕ}(x)=ReLU(Conv1dₖ₌₃(x))W where Conv1dₖ₌₃: [symbol] ^{T×d}→ [symbol] ^{T×p} (1D causal convolution with kernel size 3)

and where W∈ [symbol] ^{p×q} with q being the dimension of the fixed point of a single token. And, p can be set to be very small (e.g., 100), so that h_{Ø} is tiny and fast. Note that this 1-layer initializer by itself has very low expressivity and is a poor model for the original task.

Further still, the setting of βₖ and αᵢ^{k} 171 is parameterized. In lieu of setting the above-referenced equation

$${α}^{k} = arg {min}_{α ∈ {ℝ}^{{m}_{k} + 1}} {‖ {G}^{[ k ]} α ‖}_{2} , s . t . {1}^{⊤} α = 1 ,$$

for α a least-squares solution over the past few residuals G, both α∈ [symbol] ^{(m}^{ₖ}₊₁₎ and β∈ [symbol] are made explicit learnable functions of G with a neural network s_{ξ}: [symbol] ^{(m}^{ₖ}^{+1)×n}→( [symbol] ^{(m}^{ₖ}⁺¹⁾× [symbol] ; s

A challenge with this in view of the flowchart shown in FIG. 3A is that n (the dimension of z*) is typically large in practice, as it is affected by the scale of the input (e.g., in DEQ sequence models, n is over 1.5·10⁵ on a single textual sequence of length 200). This makes s_{ξ} map from an extremely high-dimensional space to a low-dimensional space (e.g., m=5). To keep s_{ξ} fast, small, and applicable to inputs of varying dimensionalities (e.g., sequence length or image size), each g_{θ}(z^{[k]}) can be compressed to form a smaller yet still representative version Ĝ^{[k]}of G^{[k]}=[g_{θ}(z^{[k-m}^{ₖ}^{]}), . . . , g_{θ}(z^{[k]})]. For example, when each g_{θ}(z^{[k]}) is a residual based on image feature map of dimension n=C×H×W, global pooling can be performed to form a C-dimensional vector Pool g_{θ}(z^{[k]}) as its compressed version:

Ĝ^{[k]}=[Pool(g_{θ}(x^{[k-m}^{ₖ}^{]})), . . . , Pool(g_{θ}(z^{[k]}))]∈ [symbol] ^{(m}^{ₖ}^{+1)×C}, and predict α^{k}, βₖs_{ξ}(Ĝ^{[k]}).

Once this representative collection Ĝ^{[k]} is made, it is passed through an fully-connected layer that treats the activation as a mini time-series of length mₖ+1 that encodes the latest estimates of the fixed point. A 2-layer temporal convolution is then applied to learn to predict: 1) a relative weight αᵢ^{k} for each of these past residuals i∈[mₖ]; and 2) the HyperAnderson mixing weight βₖ for the current iteration's update. The HyperAnderson network s_{ξ} therefore shall gradually learn to adjust these Anderson parameters α and β light of the previous hypersolver steps, and receive gradients from later iterations.

Regarding training the hypersolver, one benefit of training hypersolvers on implicit models is the availability of supervision via z*(x), which can be first estimated by a slower classic method. Moreover, unlike NODE solvers, a DEQ model may not have a unique trajectory and thus its hypersolvers do not need trajectory fitting at all. All that is needed is to drive everything to be as close to z* as possible. As an example, a neural solver can be encouraged to learn to sacrifice progress in earlier iterations if it subsequently converges to the equilibrium faster. Formally, given a hypersolver {h_{Ø}, s_{ξ}} that yields a set of states (z^{[k]}, G^{[k]}, α^{k}, βₖ)_{k=0, . . . ,K} (recall that z^{[0]}=h_{Ø}(x)), three objectives are introduced for training the hypersolver: fixed-point convergence loss, initializer loss, and alpha loss.

Regarding fixed-point convergence loss, this aims to encourage convergence at all intermediate estimates [z^{[k]}_{k=1, . . . ,K}] of the HyperAnderson iterations: [symbol] _{conv}=Σₖ₌₁^{K} [symbol] ₖ∥z^{[k]}−z*∥₂, where [symbol] ₖ is the weight for the loss from iteration k such that Σₖ₌₁^{K} [symbol] ₖ=1. And, [symbol] ₖ can be set to be monotonically increasing with k such that later iterations apply a heavier penalty for deviation from the fixed point.

Regarding initializer loss, the initializer is also trained by maximizing the proximity of the initial guess to the fixed point: [symbol] ᵢₙᵢₜ=∥h_{Ø}(x)−z^{*∥}₂) This objective is separated from the convergence loss [symbol] _{conv} since the initialization is predicted directly from the input x and does not go through HyperAnderson updates. Of course, this is merely exemplary.

Regarding alpha loss, although the generic Anderson solver is replaced in terms of how α^{k}, β_{K} are computed in each iteration, it is still beneficial to guide the hypersolvers' prediction of a with an auxiliary loss, especially at the start of the training: [symbol] _{α}=Σₖ₌₀^{K}∥G^{[k]}−α^{k}∥₂. In practice, the weight of this loss can be gradually decayed to 0 as training progresses.

Before entering the discussion of the Figures, below is some discussions on the various implications of the hypersolver described herein.

First, note that f_{θ} remains frozen during hypersolver training. This means that for a given DEQ model f_{θ} and input x, the fixed point z*(x)=f_{θ}(z*; x) also remains the same—but the methods described herein set out to find the fixed point faster, with a limited K-iteration budget. Moreover, we designed the initializer h_{Ø} and HyperAnderson network s_{ξ} to be intentionally simple (e.g, 1 layer with few hidden units), so that each HyperAnderson iteration is no slower, or even faster, than the original Anderson step, whose main computational overhead occurs in solving the constrained optimization in the again-reproduced equation below:

$$αk = arg {min}_{α ∈ {ℝ}^{{m}_{k} + 1}} {‖ {G}^{[ k ]} α ‖}_{2} , s . t . {1}^{⊤} α = 1 ,$$

These points also highlight the difference between the neural DEQ solver and techniques such as model compression or knowledge distillation, where a pruned/smaller (but still representationally rich) model is trained to match the output and performance of a larger model. Specifically, in the case at hand, as the fixed point z* is determined solely by f_{θ} and x, the hypersolver itself does not have to have much representational capacity, since its only goal is to produce an “educated” initial guess and learnable iterations to facilitate the optimization process. For example, the 1-layer Conv1d-based initializer described above may be a bad language model by itself since it is tiny and only sees the past 2 tokens, yet this tiny capacity and limited context can be sufficient to guide (and substantially improve) the solver.

Second, the hypersolver can be trained via backpropagation through time (BPTT). While a generic Anderson solver computes α^{k} by optimizing locally with G^{[k]}, backpropagating through the HyperAnderson steps ensures that the iterative update network s_{ξ} can receive gradient and learn from later iterations. This is advantageous because, arguably, only the output of the K^{th} iteration matters in the end. Indeed, such learned weight parameter α and other parameter β (e.g., predictors) already significantly accelerate the convergence process even without the presence of the initializer. Note that as DEQ models' f_{θ} layer is typically richly parameterized, the BPTT could consume a lot of memory if one backpropagates through many hypersolver steps. To limit memory consumption, small batch sizes can be used for hypersolver training.

Third, complementarity with DEQ regularizations is provided. Besides tiny size and fast training, the value and usefulness of neural equilibrium solvers are highlighted by how DEQ models decouple representational capacity (controlled by f_{θ}) and forward solver choice. In particular, the methods described herein are orthogonal to prior work that accelerates DEQ models by structural regularization of f_{θ} or approximating the Jacobian of f_{θ} in the backward pass. The methods disclosed herein (which are solver-based) integrate well with regularization approaches (which are f_{θ}-based) and yield broad improvements compared to canonical solvers (e.g., Broyden's method or Anderson acceleration) regardless of how f_{θ} was trained or what structure it uses.

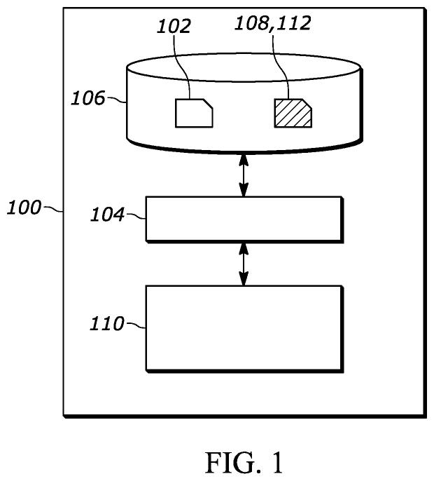

Reference is now made to the embodiments illustrated in the Figures, which can apply these teachings to a machine learning model or neural network. FIG. 1 shows a system 100 for training a neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

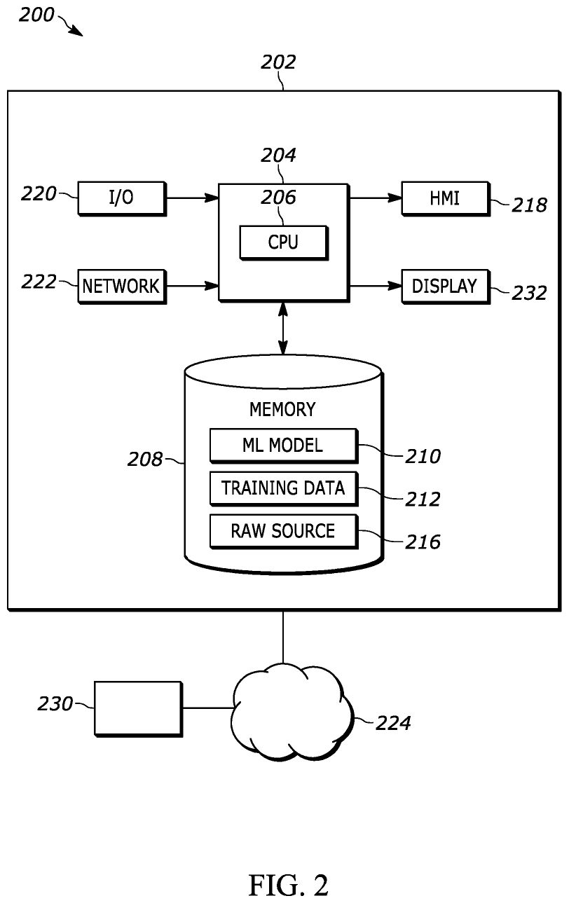

FIG. 2 depicts one embodiment of a system 200 to implement the DEQ models and associated solvers described herein. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction stet such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 330 may be in communication with the external network 224.

The computing system 202 may include an input/output (I/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

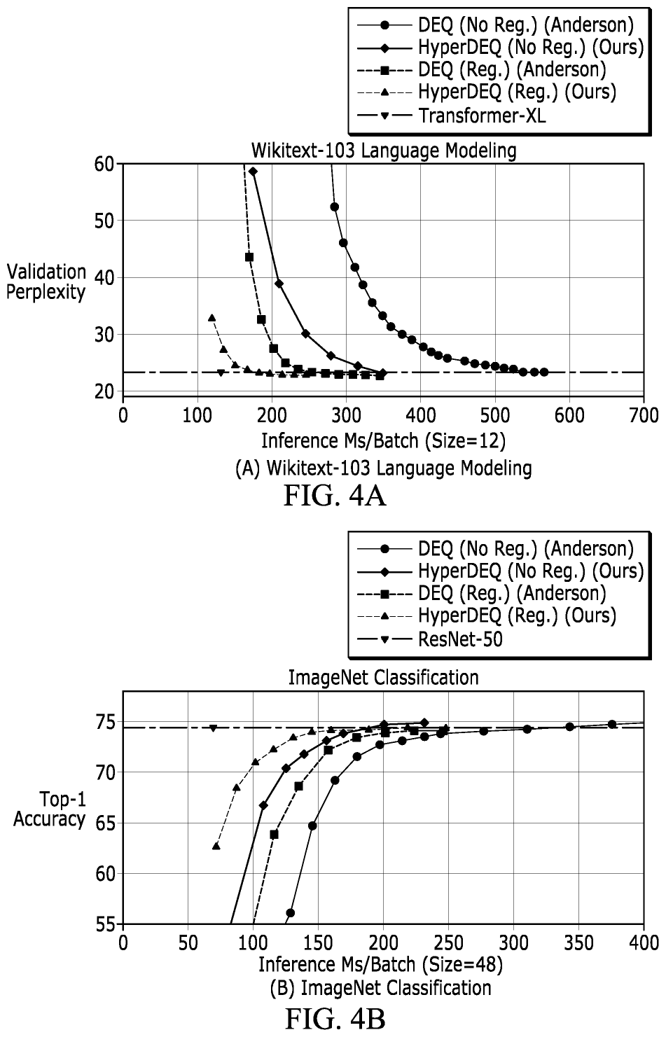

The system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time), and raw or partially processed sensor data (e.g., radar map of objects). Several different examples of inputs are shown and described with reference to FIGS. 5-11. In some examples, the machine-learning algorithm 210 may be a neural network algorithm that is designed to perform a predetermined function. For example, the neural network algorithm may be configured in automotive applications to identify pedestrians in video images. The machine-learning algorithm 210 may also be a deep equilibrium (DEQ) model.

The computer system 200 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include source videos with and without pedestrians and corresponding presence and location information. The source videos may include various scenarios in which pedestrians are identified.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), the machine-learning algorithm 210 may be executed using data that is not in the training dataset 212. The trained machine-learning algorithm 210 may be applied to new datasets to generate annotated data.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify the presence of a pedestrian in video images and annotate the occurrences. The machine-learning algorithm 210 may be programmed to process the raw source data 216 to identify the presence of the particular features. The machine-learning algorithm 210 may be configured to identify a feature in the raw source data 216 as a predetermined feature (e.g., pedestrian). The raw source data 216 may be derived from a variety of sources. For example, the raw source data 216 may be actual input data collected by a machine-learning system. The raw source data 216 may be machine generated for testing the system. As an example, the raw source data 216 may include raw video images from a camera.

In an example, the raw source data 216 may include image data representing an image. Applying the machine-learning algorithm (e.g., monotone mean-field inference model) described herein, the output can be a supplemented version of the input image that more closely resembles the actual object depicted in the image. This can be done by using Markov random fields, as described.

Given the above description of the solver for inference in deep equilibrium models (DEQs), along with the structural examples of FIGS. 1-2 configured to carry out the solver (e.g., hypersolver) and inference, the following algorithms are summarized in FIGS. 3A-3C. FIG. 3A provides a flow chart for the operation of the data processing (inference) algorithm that accelerates data processing (inference) in a machine-learning system. FIG. 3B shows an embodiment of the algorithm exemplified in FIG. 3A for utilizing the hypersolver. And, FIG. 3C provides a flow chart for an algorithm for training the hypersolver. These algorithms can be carried out using the structure described in FIGS. 1-2, for example a processor and associated memory and input/output interface utilized in a neural network setting.

Referring to FIG. 3A and 3B, the system may be configured to infer data in a DEQ neural network utilizing the hypersolver as part of the algorithms shown in these Figures. A processor(s) may receive an input from a sensor at the DEQ neural network that is operated by a fixed trained hypersolver stored in memory, and perform the following functions. Initialization is computed, i.e., a first output of the hypersolver is provided after a first iteration of the hypersolver: z^{[0]=h}_{ϕ}(x). Residuals may be defined: g_{θ}(z)=f_{θ}(z)−z. And, a residual matrix may be set: G[0]=g_{θ}(z^{[0]}). Based on the first output, a number of additional iterations of the hypersolver can be performed: k=0, . . . , K. Each additional iteration of the hypersolver can be based on an output of a previous iteration of the hypersolver. For each iteration, a weight parameter α^{k} and an additional parameter β^{k} are determined based on the hypersolver and past residuals from previous iterations of the hypersolver: \hat{α}^{k}, β^{k}=s_{ξ}(G^{[k]}) where \hat{α}^{k}=(\hat{α}₀^{k}, . . . , \hat{α}ₘ_{ₖ}^{k}) ∈ [symbol] ^{(m}^{ₖ}⁺¹). And, for each iteration, one of the past residuals from previous iterations is updated based on the weight parameter and the additional parameter; in other words, update G=concat(G[1:], [g_{θ}(z^{[k+1]})]). After the number of additional iterations of the hypersolver are complete, an output of the DEQ neural network (z^{[k+1]}) is provided based on the weight parameter, the additional parameter, and the updated past residuals.

Referring to FIG. 3C, the system may be configured to train the hypersolver for use in inference in DEQ neural networks. The training may include receiving an input x from a sensor at the DEQ. The DEQ may also receive a frozen (trained) layer function f_{θ}, hypersolver networks h_{ϕ} and s_{ξ}, and Hyperparameters K, λ₁, λ₂ and λ₃. The system may determine a first fixed point z* of the DEQ model f_{θ} based on the input x and a (generic) solver (with potentially as many solver steps as needed), and determine a second fixed point of the DEQ based on the input and a hypersolver (z^{[k]}, g_{θ}^{[k]}, α^{k}, βₖ)_{k=0, . . . , K}. A loss for the hypersolver may be derived. The loss for the hypersolver includes a fixed-point convergence loss [symbol] _{conv}=Σₖ₌₁^{K}wₖ∥z^{[k]}−z*∥₂ where wₖ is the weight for the loss from iteration k such that Σₖ₌₁^{K}wₖ=1. The loss may also include an initializer loss [symbol] ᵢₙᵢₜ=∥h_{ϕ}(x)−z*∥₂ and an alpha loss [symbol] _{α}=Σₖ₌₁^{K}wₖ∥G^{[k]}α^{k}∥₂. The overall loss for the hypersolver ( [symbol] (ω, K)=λ₁ [symbol] _{conv}+λ₂ [symbol] ᵢₙᵢₜλ₃ [symbol] _{α} where ω={ϕ, ξ}) represents a difference between an output of the solver and an output of the hypersolver. The system may update parameters of the hypersolver using loss gradients of the loss for the hypersolver: ∇_{ϕ} [symbol] (ω, K)=λ₂∇_{ϕ} [symbol] ᵢₙᵢₜ and ∇_{ξ} [symbol] (ω, K)=λ₁∇_{ξ} [symbol] _{conv}+λ₃∇_{ξ} [symbol] _{α}. The determining of the first fixed point and the second fixed point, the deriving of the loss, and the updating of the parameters may all be repeated until convergence of training of the hypersolver. Finally, a trained hypersolver is output. This trained hypersolver may be used in DEQ, such as that explained throughout and shown in FIGS. 3A-3B for example.

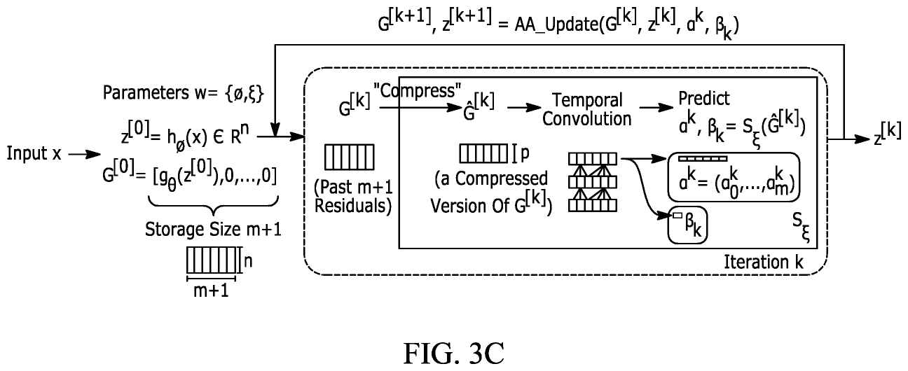

Referring to FIGS. 4A-4D, evaluations of the performance of the neural equilibrium solvers disclosed herein are shown. The solvers are evaluated based on three different tasks: WikiText-103 language modeling (FIG. 4A), ImageNet classification (FIG. 4B), and Cityscapes semantic segmentation (FIG. 4C), which are the large-scale, high-dimensional tasks for implicit models. Here, the wall-clock inference speed is measured directly (e.g., batch size, input scale, etc.).

Regarding FIG. 4A, f_{θ} is a Transformer layer [52, 15, 4] and the fixed points z* are (embeddings of) text sequences. The neural solver is trained on sequences of length 60 for 5000 steps, and its inference-time effect is shown in FIG. 4A (where a validation sequence length of 150 is used). Specifically, compared with the original DEQ-Transformer (Y curve, furthest to the right), which uses generic Anderson acceleration or Broyden's method (both have similar pareto curves), this same DEQ model solved with the neural approach disclosed herein (dubbed HyperDEQ; see curve second to the right) achieves significantly better pareto efficiency. Moreover, the HyperDEQ builds faster implicit models by regularization on the Jacobians. To demonstrate this, a DEQ-Transformer model is also trained with Jacobian regularization (the curve third to the right), and the neural solver is applied on this regularized DEQ (the curve fourth to the right, i.e., first on the left). This movement of the speed/perplexity curves validates the DEQ property disclosed herein: the decoupling of the representational capacity (i.e., f_{θ}) and the forward computation (i.e., the solver). With everything combined, the performance of implicit Transformer-based DEQs is brought close to the explicit Transformer-XL, which is the state-of-the-art architecture on this task. This is a significant step towards making implicit models practical and appealing for realistic applications.

Regarding FIG. 4B, the neural deep equilibrium solver is additionally applied to ImageNet classification (224×224 images), where the hypersolver is trained on top of frozen, standard 4-resolutional multiscale DEQ models. The HyperDEQ is trained with 12 HyperAnderson iterations, and the speed/accuracy curves are shown in FIG. 4B (the first and second curves on the left). Note that while Jacobian regularization of DEQ models (the third curve from the left) eventually hurts performance when compared to the original multiscale DEQ (curve fourth from the left, i.e. first from the right) as it imposes strong constraints on the model, the neural solver disclosed herein achieves faster inference without sacrificing any accuracy (since f_{θ}, and thus z*, are the same); e.g., the system reaches 75.0% accuracy while being almost 2× faster than before.

Regarding FIG. 4C, the neural solver approach disclosed herein is shown to work well in domains where regularization-based methods may fail. Specifically, the neural equilibrium solver disclosed herein is applied on Cityscapes semantic segmentation, where the task objective is to label every pixel on a high-resolution (typically 2048×1024) image with the class of the object that the pixel belongs to. As in the ImageNet and WikiText-103 tasks, there is a consistent gain in using the neural solver over the generic alternative, accelerating fixed-point covergence by more than a factor of 2 (see FIG. 4C). In contrast, prior methods such as Jacobian regularization do not work in this setting, due to their dependence on the exact structure of f_{θ}. (Specifically, when f_{θ} is convolution-based and the image is very large, Jacobian regularization that encourages contractivity is at odds with the gradual broadening of the receptive field by the model.) The neural solver disclosed herein is essentially orthogonal to the structure of f_{θ}; it is applied on an already-trained DEQ, and the solver's function improves.

Regarding FIG. 4D, an overhead comparison is shown, exemplifying that the training overhead of the hypersolver disclosed herein is extremely small. Not only is this hypersolver approach effective, but the overhead for training the hypersolver is also extremely small: the neural solver module is tiny (<4% of the DEQ model size) and requires only about 1% of the training time required to train the original DEQ model (e.g., on WikiText-103, training a DEQ may requires 130 hours on 4 GPUs; the neural solver may require only about 1.2 extra hours). This is strong evidence that neural solvers are simple, lightweight, and effective tools that take advantage of the properties of equilibrium models to yield an almost-free acceleration at inference time.

The disclosure up until now shows a neural fixed-point solver for DEQ models. The approach is simple, customizable, and extremely lightweight. Unlike prior works that may accelerate or stabilize equilibrium models by regularizing the structures or parameterizations of the layer itself (usually at the cost of accuracy), we propose to take advantage of how DEQ networks decouple the representation (i.e., f_{θ}) from the inference process. We directly learn a model-specific equilibrium solver that provides: 1) better-informed initial guesses for the optimization procedure; and 2) parameterized iterations that generalize Anderson acceleration and are modeled as a temporal process to take into account future steps. These modifications substantially improve the speed/accuracy trade-off across diverse large-scale tasks, while adding almost no overhead to training.

FIG. 5 depicts a schematic diagram of an interaction between computer-controlled machine 500 and control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic and motion sensors. In one embodiment, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes classifier 514. Classifier 514 may be configured to classify input signals x into one or more labels using a machine learning (ML) algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In another embodiment, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In another embodiment, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., ML algorithms) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more ML algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C #, Objective C, Fortran, Pascal, Java Script, Python, Perl, and PL/SQL.

Upon execution by processor 520, the computer-executable instructions of non-volatile storage 516 may cause control system 502 to implement one or more of the ML algorithms and/or methodologies as disclosed herein. Non-volatile storage 516 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

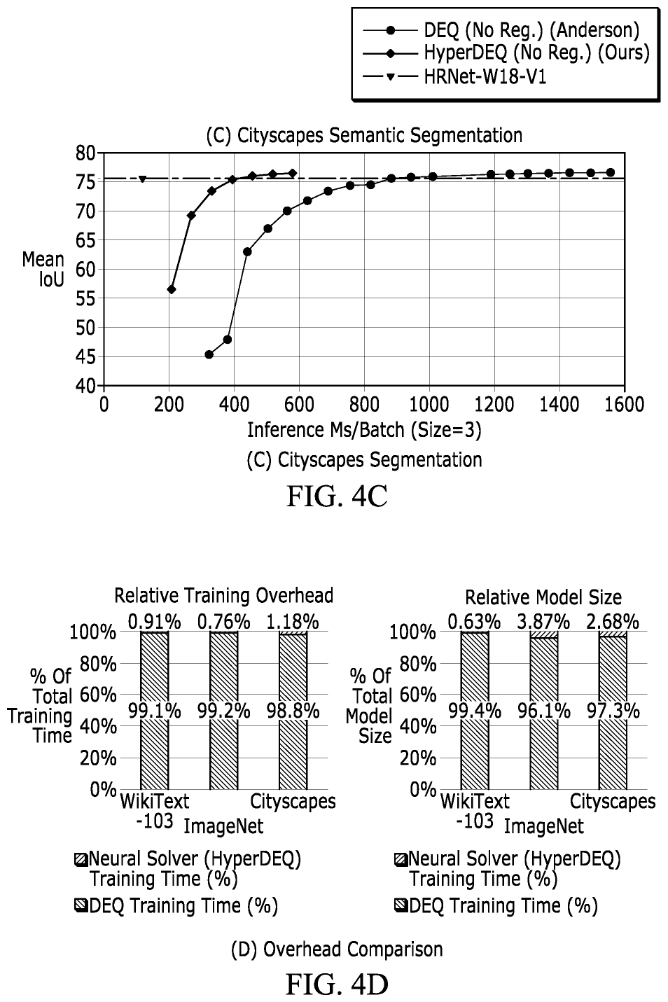

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects.

In embodiments where vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In other embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In another embodiment, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

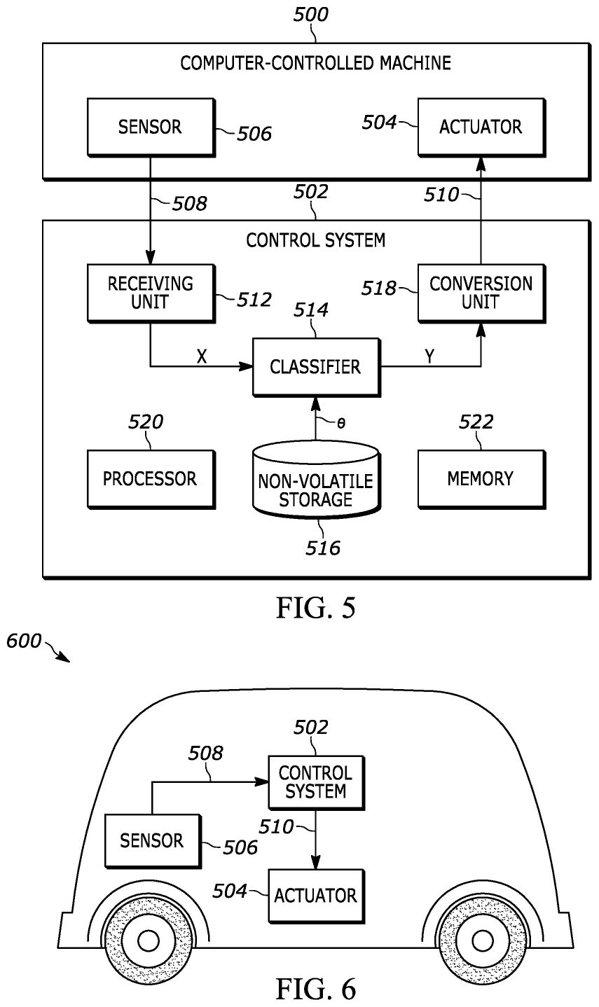

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 106 of system 700 (e.g., manufacturing machine) depending on the determined state of manufactured product 704.

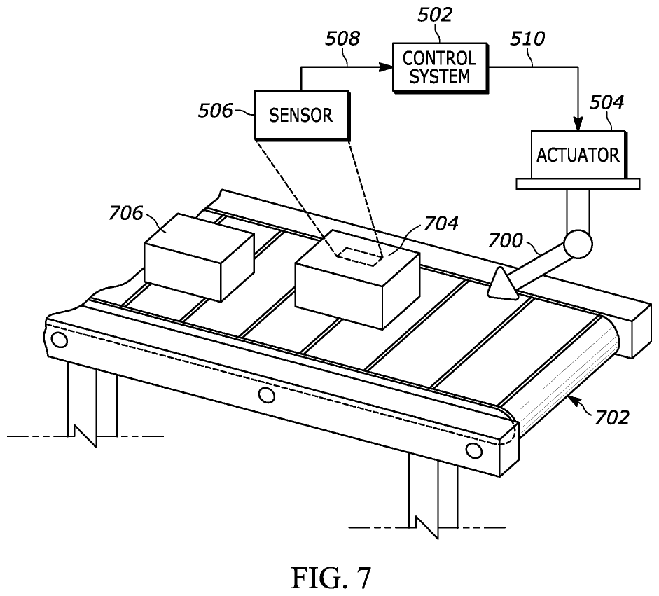

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

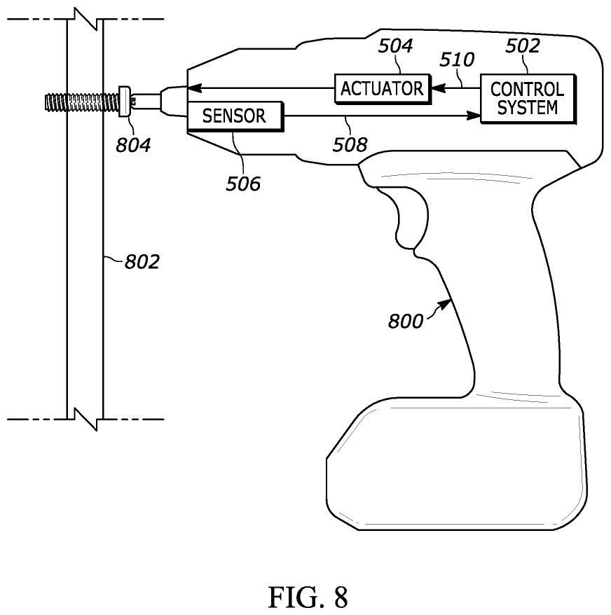

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

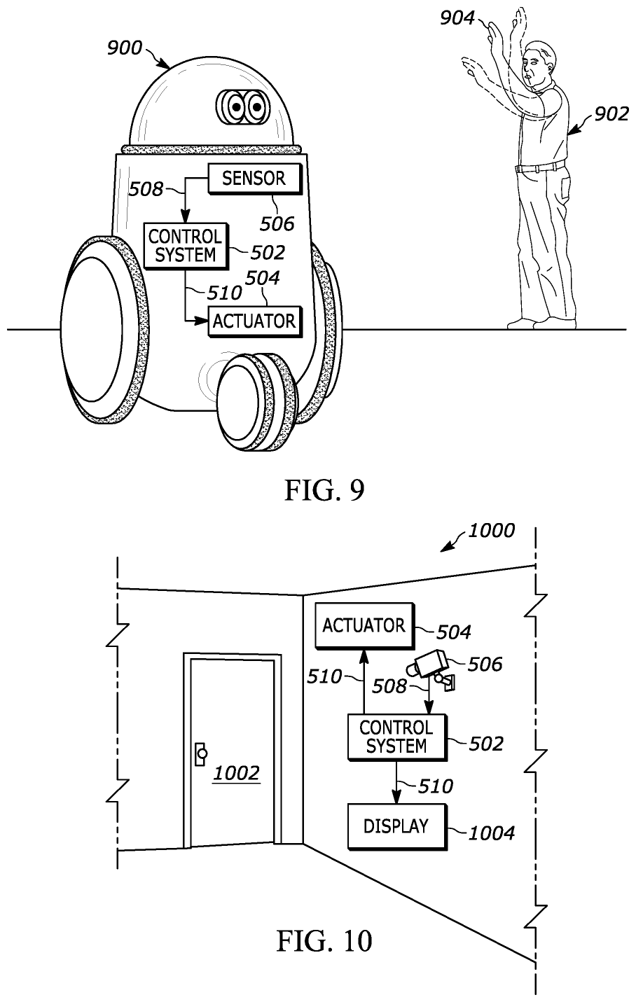

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In other embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

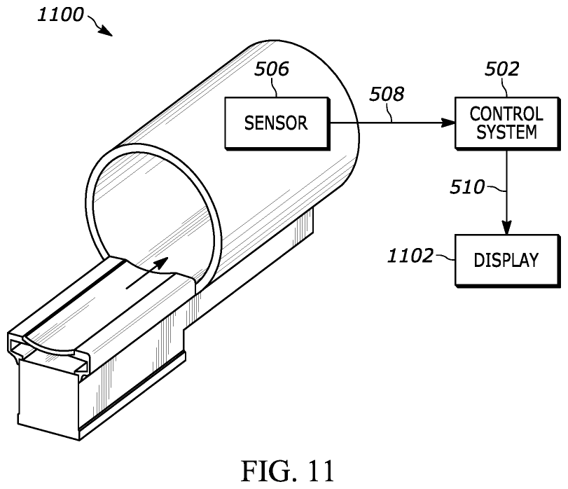

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 302 to display the imaging and highlighting the potentially anomalous region.

References herein are made to convergence. The system may determine that convergence is met based on a threshold or another attribute. For example, the threshold utilized for convergence may be met by a defined number of iterations, an amount of error loss, the amount of classification error, loss value (e.g., average or sum), or other attributes.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method of inferring data in a deep equilibrium (DEQ) neural network, the computer-implemented method comprising:
receiving an input from a sensor at the DEQ neural network that is operated by a trained hypersolver stored in memory;
providing a first output of the hypersolver after a first iteration of the hypersolver;
based on the first output, begin performing a number of additional iterations of the hypersolver, wherein each additional iteration of the hypersolver is based on an output of a previous iteration of the hypersolver, wherein for each additional iteration:
a weight parameter and an additional parameter are determined based on the hypersolver, and past residuals from previous iterations of the hypersolver, and
one of the past residuals from the previous iterations is updated based on the weight parameter and the additional parameter; and
after the number of additional iterations of the hypersolver are complete, providing an output of the DEQ neural network based on the weight parameter, the additional parameter, and the updated past residuals.

2. The computer-implemented method of claim 1, wherein the past residuals is a matrix of past residuals.

3. The computer-implemented method of claim 1, wherein the weight parameter is determined in a greedy manner at each of the additional iterations.

4. The computer-implemented method of claim 1, wherein the input includes image data.

5. The computer-implemented method of claim 1, wherein the sensor includes a camera, global positioning system (GPS) sensor, temperature sensor, oxygen sensor, speed sensor, or a vehicle sensor.

6. The computer-implemented method of claim 1, wherein the hypersolver is a fixed hypersolver, fixed throughout the first iteration and the number of additional iterations.

7. A computer-implemented method for training a hypersolver for inference in a deep equilibrium (DEQ) neural network, the computer-implemented method comprising:
(i) receiving an input from a sensor at the DEQ;
(ii) determining a first fixed point of the DEQ based on the input and a solver;
(iii) determining a second fixed point of the DEQ based on the input and a hypersolver;
(iv) deriving a loss for the hypersolver, wherein the loss for the hypersolver includes a fixed-point convergence loss representing a difference between an output of the solver and an output of the hypersolver;
(v) updating parameters of the hypersolver using loss gradients of the loss for the hypersolver;
(vi) repeating steps (ii)-(v) until convergence of training of the hypersolver; and
(vi) outputting a trained hypersolver for use in inference in the DEQ.

8. The computer-implemented method of claim 7, wherein the loss includes an initializer loss.

9. The computer-implemented method of claim 7, wherein the loss includes a loss of a weight parameter.

10. The computer-implemented method of claim 7, further comprising storing the trained hypersolver in memory, and accessing the trained hypersolver for inference in a use of the DEQ neural network.

11. The computer-implemented method of claim 7, wherein the input includes image data.

12. The computer-implemented method of claim 7, wherein the sensor includes a camera, global positioning system (GPS) sensor, temperature sensor, oxygen sensor, speed sensor, or a vehicle sensor.

13. The computer-implemented method of claim 7, wherein the solver is a generic Anderson solver.

14. The computer-implemented method of claim 7, wherein the hypersolver is a fixed hypersolver, fixed throughout steps (ii)-(v).

15. A system including a machine-learning network, the system comprising:
an input interface configured to receive, at a deep equilibrium (DEQ) neural network operated by a trained hypersolver stored in memory, input data from a sensor; and
a processor in communication with the input interface and programmed to:
receive the input data from the sensor;
provide a first output of the hypersolver after a first iteration of the hypersolver;
based on the first output, begin performing a number of additional iterations of the hypersolver, wherein each additional iteration of the hypersolver is based on an output of a previous iteration of the hypersolver, wherein for each additional iteration:
a weight parameter and an additional parameter are determined based on the hypersolver, and past residuals from previous iterations of the hypersolver, and
one of the past residuals from the iterations is updated based on the weight parameter and the additional parameter; and
after the number of additional iterations of the hypersolver are complete, provide an output of the DEQ neural network based on the weight parameter, the additional parameter, and the updated past residuals.

16. The system of claim 15, wherein the past residuals is a matrix of past residuals.

17. The system of claim 15, wherein the weight parameter is determined in a greedy manner at each of the additional iterations.

18. The system of claim 15, wherein the input includes image data, video data, text-based information, human speech, or time series data.

19. The system of claim 15, wherein the sensor includes a camera, global positioning system (GPS) sensor, temperature sensor, oxygen sensor, speed sensor, or a vehicle sensor.

20. The system of claim 15, wherein the hypersolver is a fixed hypersolver, fixed throughout the first iteration and the number of additional iterations.
